(19) United States
(12) Patent Application Publication
(10) Pub. No.: US 2012/0030697 A1
(43) Pub. Date: Feb. 2, 2012

(54) DISPLAY CONTROL APARATUS, DISPLAY CONTROL METHOD, PROGRAM, AND RECORDING MEDIUM

(76) Inventor: Yoshiki Yamamoto, Osaka (JP)

(21) Appl. No.: 13/262,999

(22) PCT Filed: Apr. 14, 2010
(86) PCT No.: PCT/JP2010/002698

§ 371 Date: Oct. 5, 2011

(30) Foreign Application Priority Data
Apr. 23, 2009 (JP) 2009-104955

(51) Int. Cl. H04H 60/32

(52) U.S. Cl. 725/14

(57) ABSTRACT

In the conventional program recommend method, there is a problem that the user misses to view a program being wanted to view or a problem that the information is redundant to the user. A display control apparatus of the present invention includes a preference information acquisition unit which acquires a preference information of a viewer from the broadcast reception apparatus, a program information acquisition unit which acquires the program information of a preference target program which suits the preference information, from the server, a reception apparatus state detection unit which detects an instruction of a power supply off to the broadcast reception apparatus, a program information display unit which displays at least a part of the program information, and a display control unit which controls a start of a display of the program information, on the basis of the instruction of the power supply off.

### CROSS-REFERENCE TO RELATED APPLICATIONS

This application is a U.S. national phase application of PCT International Patent Application No. PCT/JP2010/002698 filed Apr. 14, 2010, claiming the benefit of priority of Japanese Patent Application No. 2009-104955 filed Apr. 23, 2009, all of which are incorporated by reference herein in their entirety.

### TECHNICAL FIELD

The present invention relates to a display control apparatus, a display control method, and the like, which display program information related to a program which suits a preference of a viewer.

### BACKGROUND ART

In recent years, a technology development, which prevents a user from missing to view a program that a user wants to view, has advanced. As one method of the technologies, a development of such technology is carried out. The technology acquires user's preference information from a viewing history or the like, and the technology, on the basis of the user's preference information which is acquired, receives a program which suits user's preference or displays the program information.

As a method for displaying the program information which suits the user's preference, there is such method (for example, referring to Japanese Patent Application Laid-Open No. 2007-267093) that a display control terminal which creates program information displays explicitly the program which suits the user's preference in a program guide by acquiring the program information from a server and acquiring the user's preference information from a recording apparatus.

The conventional display method of the program information, which is disclosed in Japanese Patent Application Laid-Open No. 2007-267093, is described below.

FIG. 11 is a block diagram illustrating a configuration of the recording and viewing reservation system which is disclosed in Japanese Patent Application Laid-Open No. 2007-267093.

A display control terminal 421, an access point 422, a router 423 and a recording apparatus 424 are connected to each other through a home LAN 413. The display control terminal 421 has a function as a remote commander that remote-controls the recording apparatus 424 or a picture display sound reproduction apparatus 425 according to a user's operation. And the display control terminal 421 controls the recording apparatus 424 or the like via the access point 422.

The home LAN 413 is connected to the internet 412 via the router 423. The display control terminal 421 acquires program information about the program which is broadcasted, from a program information server 411 via the internet 412. And the display control terminal 421 acquires at least one of information of program reservation, information of result of program recording and preference information indicating the user's preference, from an operating apparatus of the user such as the recording apparatus 424. The display control terminal 421 selects, from among the programs specified by the acquired information, a program of which broadcast time is nearest to the current time as an initial program which is to be noted when a display of the program guide is started.

When the displaying of the program guide is started on the LCD of the display control terminal 421, the initial program of the program guide is displayed with a notable state.

By displaying in this way, it is possible to show the program information which suits user's preference, to the user.

Japanese Patent Application Laid-Open No. 2008-167263 discloses a method which provides the second display apparatus displaying information about the broadcast program, besides the display apparatus (the first display apparatus) displaying the broadcast program received. By displaying information promoting viewing of the program on this second display apparatus, a method which prevents a user from missing to view the program which is wanted to be viewed, can be provided.

### SUMMARY OF INVENTION

### Technical Problem

However, the conventional program recommendation method described above cannot show recommended programs in an appropriate timing. Then, there is a problem that the user misses to view a program which is wanted to be viewed or a problem that the information is redundant to the user.

That is, in the program recommendation method disclosed in Japanese Patent Application Laid-Open No. 2007-267093, the recommended programs are not displayed unless the user operates to display the program guide. Therefore, when the user powers off the apparatus without displaying the program guide, the user misses to view the program which the user wants to view, without confirming the recommended programs.

In the method displaying the viewing recommendation information of the program or the like, by using the conventional method described in Japanese Patent Application Laid-Open No. 2008-167263 which displays information about the programs on the display apparatus (the second display apparatus) other than the apparatus (the first display apparatus) displaying the broadcast program received, the viewing recommendation information of the program or the like is displayed on the second display apparatus regardless of a power supply state of the first display apparatus. Therefore, even if the user is viewing a television program on the first display apparatus and then the user doesn't miss to view the program which the user wants to view, the viewing recommendation information or the like is shown. Then, the information is redundant to the user.

The present invention intends to offer, in consideration of the conventional problems described above, such a display control apparatus, a display control method and the like that can prevent a user from missing to view a preference program by showing recommended programs according to user's preference information in an appropriate timing, without offering redundant information.

### SUMMARY OF THE INVENTION

The 1^{st} aspect of the present invention is a display control apparatus which is connected through a network to a server having program information, works in cooperation with a broadcast reception apparatus having a display function, and controls a display of the program information of a broadcast program, the display control apparatus comprising:

a preference information acquisition unit which acquires a preference information of a viewer from the broadcast reception apparatus;

a program information acquisition unit which acquires the program information of a preference target program which suits the preference information, from the server;

a reception apparatus state detection unit which detects at least one of an instruction of a power supply off to the broadcast reception apparatus and an instruction of a change of channels to the broadcast reception apparatus;

a program information display unit which displays at least a part of the program information; and

a display control unit which controls a start of a display of the program information, on the basis of at least one of the instruction of the power supply off and the instruction of the change of channels.

The 2^{nd} aspect of the present invention is the display control apparatus according to the 1^{st} aspect of the present invention, comprising:

a search unit which searches the preference target program which suits the preference information; and

a communication unit which receives the program information about the preference target program specified by the search unit, from the server, wherein

the program information acquisition unit acquires the program information of the preference target program from the communication unit.

The 3^{rd} aspect of the present invention is the display control apparatus according to the 2^{rd} aspect of the present invention, wherein

the search unit performs the search of the preference target program against an EPG information which is acquired from the broadcast reception apparatus.

The 4^{th} aspect of the present invention is the display control apparatus according to the 1^{st} aspect of the present invention, comprising a communication unit which transmits the preference information to the server and receives the program information of the preference target program which suits the preference information, the preference target program being searched by the server, wherein

the program information acquisition unit acquires the program information of the preference target program from the communication unit.

The 5^{th} aspect of the present invention is the display control apparatus according to the 1^{st} aspect of the present invention, wherein

the display control unit controls in such a manner that the display of the program information starts in a case that a channel after the change of channel differs from a channel of the preference target program, when the instruction of the change of channels is detected.

The 6^{th} aspect of the present invention is the display control apparatus according to the 5^{th} aspect of the present invention, wherein

the display control unit controls in such manner that the display of the program information starts only in a case that a channel before the change of channel is the same as the channel of the preference target program, when the instruction of the change of channels is detected.

The 7^{th} aspect of the present invention is the display control apparatus according to the 1^{st} aspect of the present invention, wherein

the program information display unit is not built into a body section of the display control apparatus but is arranged outside of the body section.

The 8^{th} aspect of the present invention is the display control apparatus according to the 1^{st} aspect of the present invention, wherein

the display control apparatus is incorporated in the broadcast reception apparatus, and

a screen serves as the program information display unit, the screen displaying a picture of the broadcast program of the broadcast apparatus.

The 9^{th} aspect of the present invention is a display control method which acquires program information of a broadcast program through a network from a server having the program information, works in cooperation with a broadcast reception apparatus having a display function, and displays the program information, the display control method comprising:

a preference information acquisition step of acquiring a preference information of a viewer from the broadcast reception apparatus;

a program information acquisition step of acquiring the program information of a preference target program which suits the preference information, from the server;

a reception apparatus state detection step of detecting at least one of an instruction of a power supply off to the broadcast reception apparatus and an instruction of a change of channels to the broadcast reception apparatus; and

a display control step of controlling a start of a display of the program information, on the basis of at least one of the instruction of the power supply off and the instruction of the change of channels.

The 10^{th} aspect of the present invention is a non-transitory computer-readable medium having a program stored thereon for causing a computer to execute the display control method according to claim 9.

The 12^{th} aspect of the present invention is the display control apparatus according to the 2^{rd} aspect of the present invention, wherein

the program information display unit is not built into a body section of the display control apparatus but is arranged outside of the body section.

The 13^{th} aspect of the present invention is the display control apparatus according to the 3^{rd} aspect of the present invention, wherein

the program information display unit is not built into a body section of the display control apparatus but is arranged outside of the body section.

The 14^{th} aspect of the present invention is the display control apparatus according to the 4^{th} aspect of the present invention, wherein

the program information display unit is not built into a body section of the display control apparatus but is arranged outside of the body section.

The 15^{th} aspect of the present invention is the display control apparatus according to the 5^{th} aspect of the present invention, wherein

the program information display unit is not built into a body section of the display control apparatus but is arranged outside of the body section.

The 16^{th} aspect of the present invention is the display control apparatus according to the 6^{th} aspect of the present invention, wherein

the program information display unit is not built into a body section of the display control apparatus but is arranged outside of the body section.

The 17^{th} aspect of the present invention is the display control apparatus according to the 2^{nd} aspect of the present invention, wherein

the display control apparatus is incorporated in the broadcast reception apparatus, and

a screen serves as the program information display unit, the screen displaying a picture of the broadcast program of the broadcast apparatus.

The 18^{th} aspect of the present invention is the display control apparatus according to the 3^{rd} aspect of the present invention, wherein

the display control apparatus is incorporated in the broadcast reception apparatus, and

a screen serves as the program information display unit, the screen displaying a picture of the broadcast program of the broadcast apparatus.

The 19^{th} aspect of the present invention is the display control apparatus according to the 4^{th} aspect of the present invention, wherein

the display control apparatus is incorporated in the broadcast reception apparatus, and

a screen serves as the program information display unit, the screen displaying a picture of the broadcast program of the broadcast apparatus.

The 20^{th} aspect of the present invention is the display control apparatus according to the 5^{th} aspect of the present invention, wherein

the display control apparatus is incorporated in the broadcast reception apparatus, and

a screen serves as the program information display unit, the screen displaying a picture of the broadcast program of the broadcast apparatus.

The 21^{st} aspect of the present invention is the display control apparatus according to the 6^{th} aspect of the present invention, wherein

the display control apparatus is incorporated in the broadcast reception apparatus, and

a screen serves as the program information display unit, the screen displaying a picture of the broadcast program of the broadcast apparatus.

### Advantage of the Invention

The present invention can provide such a display control apparatus, a display control method and the like that can prevent a user from missing to view a preference program by showing recommended programs according to user's preference information in an appropriate timing, without offering redundant information.

### BRIEF DESCRIPTION OF THE DRAWINGS

FIG. 1 is a block diagram of constitutions of a display control apparatus, a television and a center apparatus according to a first embodiment of the present invention;

FIG. 2 is a flow chart for illustrating a process flow of the display control apparatus according to the first embodiment of the present invention;

FIG. 3 (a) is a flow chart for illustrating a process flow of the display control apparatus when the display control apparatus acquires the program information in advance, according to the first embodiment of the present invention;

FIG. 3 (b) is a flow chart for illustrating a process flow of the display control apparatus when the display control apparatus acquires the program information in advance, according to the first embodiment of the present invention;

FIG. 4 is a block diagram of constitutions of a display control apparatus, a television and a center apparatus having another constitution, according to the first embodiment of the present invention;

FIG. 5 is a block diagram of constitutions of a display control apparatus, a television and a center apparatus according to a second embodiment of the present invention;

FIG. 6 is a flow chart for illustrating a process flow of the display control apparatus according to the second embodiment of the present invention;

FIG. 7 (a) is a flow chart for illustrating a process flow of the display control apparatus when the display control apparatus acquires the program information in advance, according to the second embodiment of the present invention;

FIG. 7 (b) is a flow chart for illustrating a process flow of the display control apparatus when the display control apparatus acquires the program information in advance, according to the second embodiment of the present invention;

FIG. 8 is a block diagram of constitutions of a display control apparatus, a television and a center apparatus having another constitution, according to the second embodiment of the present invention;

FIG. 9 is a block diagram of constitutions of a display control apparatus, a television and a center apparatus according to a third embodiment of the present invention;

FIG. 10 is a flow chart for illustrating a process flow of the display control apparatus according to the third embodiment of the present invention; and

FIG. 11 is a block diagram for illustrating a conventional recording and viewing reservation system.

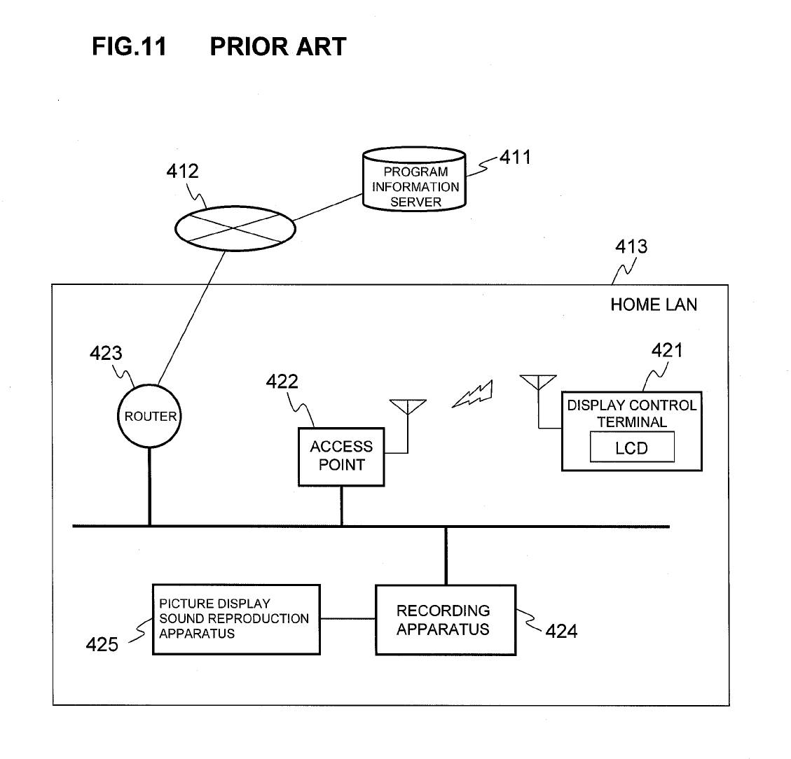

### MODES FOR CARRYING OUT THE INVENTION

Hereinafter, best modes of embodiments of the present invention are described with reference to the drawings.

### First Embodiment

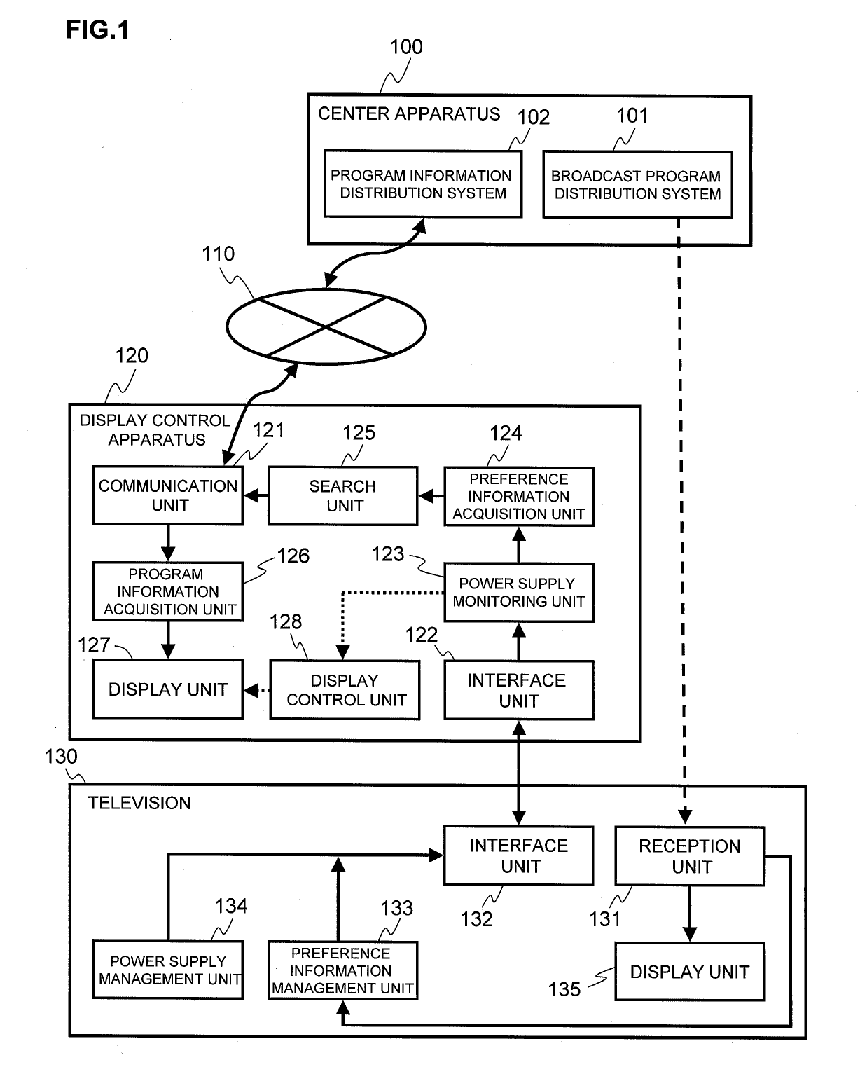

A block diagram of constitutions of a display control apparatus, a television and a center apparatus according to a first embodiment of the present invention are shown in FIG. 1.

In FIG. 1, the display control apparatus 120 of the first embodiment has a communication unit 121 which communicates with other equipments (corresponding to a program information distribution system 102 here) through a network 110 such as an internet, an interface unit 122 which communicates with the television 130 receiving and displaying the broadcast, a power supply monitoring unit 123 which monitors a power supply state of the television 130, a preference information acquisition unit 124 which acquires user's preference information at the television 130, a search unit 125 which searches on the basis of the preference information acquired by the preference information acquisition unit 124, a program information acquisition unit 126 acquires program information through the network from an other equipment on the basis of a result of the search of the search unit 125, a display unit 127 which displays the program information, and a display control unit 128 which controls a display timing of the display unit 127.

The program information distribution system 102 corresponds to an example of a server according to the present invention. The power supply monitoring unit 123 corresponds to an example of a reception apparatus state detection unit according to the present invention. The display unit 127 corresponds to an example of a program information display unit according to the present invention.

A network communication apparatus or the like which has a small liquid crystal display corresponds to an example of the display control apparatus 120 of the first embodiment.

A center apparatus 100 which connects with the display control apparatus 120 through the network 110, consists of a broadcast program distribution system 101 and the program information distribution system 102. But the program information distribution system 102 can be provided separately from the center apparatus 100.

On the other hand, the television 130 connected to the display control apparatus 120 has a reception unit 131 which receives and decodes a program broadcasted from the broadcast program distribution system 101 of the center apparatus 100, an interface unit 132 which communicates with the display control apparatus 120, a preference information management unit 133 which picks out and manages user's preference program information from a viewing history or the like, a power supply management unit 134 which manages the power supply of the television 130, and a display unit 135 which displays the broadcast program decoded by the reception unit 131.

The television 130 corresponds to an example of a broadcast reception apparatus having a display function according to the present invention.

In the television 130, the reception unit 131 receives and decodes the broadcast program distributed by the broadcast program distribution system 101. The information about the program received and decoded, is recorded in the preference information management unit 133 as a viewing history. The preference information management unit 133 picks out user's preference history from information related to the viewing history such as the viewing history, viewing time, viewing number of times or the like.

The broadcast program which is received and decoded by the reception unit 131 is displayed by the display unit 135.

The power supply management unit 134 monitors and controls the power supply state such as power-on, power-off or the like.

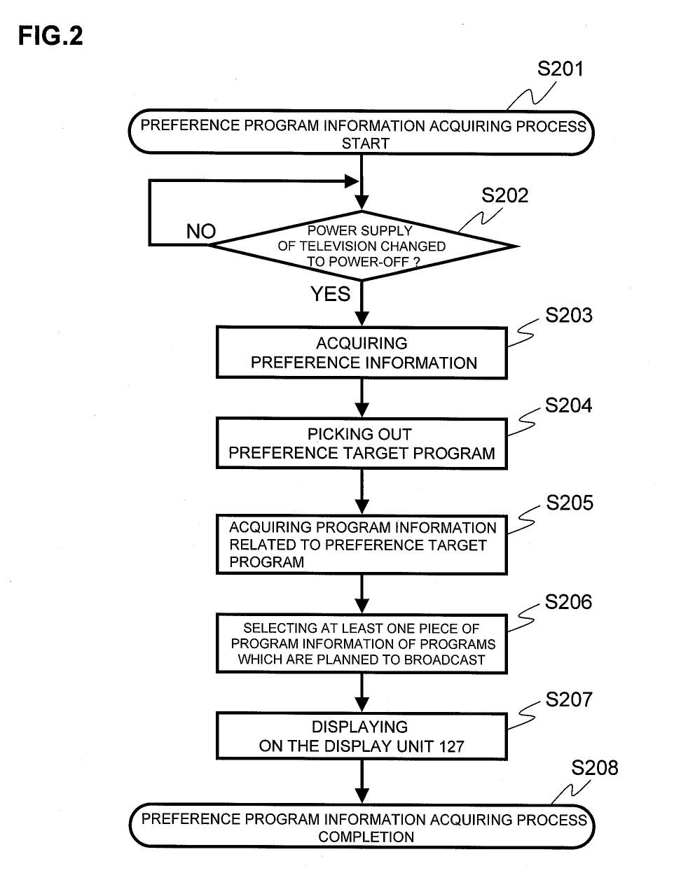

Then, the flow of the process of the display control apparatus 120 of the first embodiment is described with reference to FIG. 2. FIG. 2 illustrates a flowchart indicating the flow of the process of the display control apparatus 120 of the first embodiment.

In FIG. 2, when the preference program information acquiring process is started (step S201) by the display control apparatus 120, the power supply monitoring unit 123 of the display control apparatus 120 checks whether the power supply state of the television 130 is changed to power-off or not (step S202). The information related to the power supply state of the television 130 is outputted through the interface unit 132 of the television 130 from the power supply management unit 134 of the television 130. The power supply monitoring unit 123 of the display control apparatus 120 receives the information related to the power supply through the interface unit 122 and checks whether the power supply state is changed to power-off or not.

The wording of “the power supply state is changed to power-off” means that the power supply for displaying of the television 130 changes to power-off. Even if the power supply state of the television 130 is changed to power-off, the interface unit 132, the preference information management unit 133 and the power supply management unit 134 can work by a standby power.

The information related to the power supply state which is received by the power supply monitoring unit 123 through the interface unit 122, corresponds to an example of an instruction of a power supply off according to the present invention.

At step S202, when it is checked that the power supply state is not changed to power-off (“NO” in step S202), the flow returns to step S202 again. And the check on whether the power supply state is changed to power-off or not, is carried out repeatedly until it is confirmed that the power supply state is changed to power-off.

At step S202, when it is confirmed that the power supply state of the television 130 is changed to power-off (“YES” in step S202), the preference information acquisition unit 124 of the display control apparatus 120 acquires the user's preference information through the interface unit 122 from the preference information management unit 133 of the television 130 (step S203).

The search unit 125 picks out a program (referred as a preference target program), which the user possibly wants to view, on the basis of the preference information acquired from the television 130 by the preference information acquisition unit 124 (step S204).

The search unit 125 acquires the EPG information from the preference information management unit 133 of the television 130, searches the EPG information to pick out the preference target program on the basis of the preference information such as genre, day of the week, period of time or the like which the user viewed often. Then, the search unit 125 can use any kind of method to pick out the preference target program. For example, the search unit 125 can search on the basis of only information of the genre which the user viewed often, to pick out the preference target program.

The communication unit 121 acquires the program information related to the preference target program, which is picked out by the search unit 125, through the network 110 from the program information distribution system 102 (step S205). The program information acquisition unit 126 acquires the program information related to the preference target program through the communication unit 121, selects at least one piece of the program information related to programs which are planned to broadcast soon, from among the program information related to the preference target program acquired by the program information acquisition unit 126 (step S206), and outputs the selected program information to the display unit 127.

The wording of “programs which are planned to broadcast soon”, for example, means the programs which are planned to start to broadcast within a predetermined time (for example, within 3 hours) based on the current time.

When the display control unit 128 acquires the detection result indicating that the power supply state of the television 130 is changed to power-off, from the power supply monitoring unit 123, the display control unit 128 controls the display unit 127 to display the inputted program information (step S207), and completes the preference program information acquiring process (step S208).

In the first embodiment described above, the search unit 125 decides about the process (step S204) for picking out the preference target program. But the preference target program can be picked out by the center apparatus 100. For example, the search unit 125 can acquire the genre, the time information or the like from the preference information management unit 133 to control the transmission of the genre or the time information as a keyword to the program information distribution system 102 so that the preference target program which is applicable to the keyword can be picked out by the program information distribution system 102.

For the method of connecting the display control apparatus 120 and the television 130, HDMI-CEC (High-Definition Multimedia Interface-Consumer Electronics Control), IP (Internet Protocol) or the like can be used. But the method is not limited in particular.

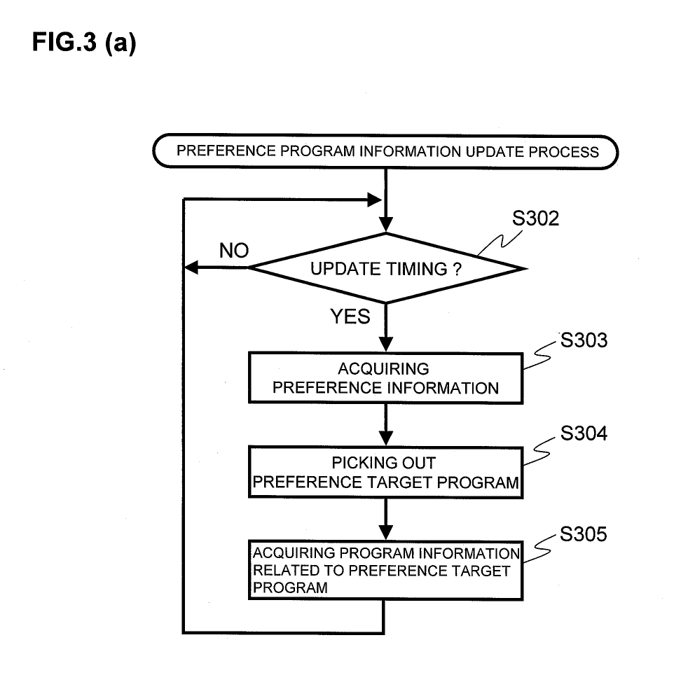

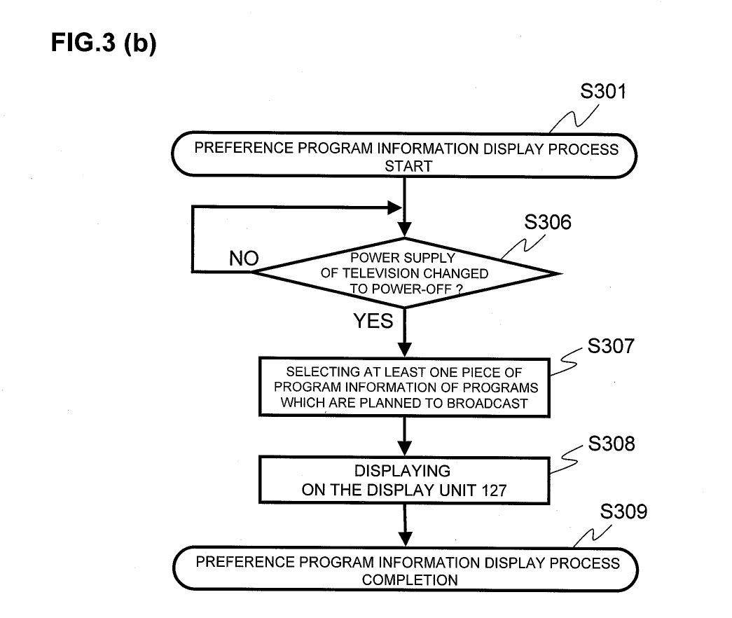

Then, the flow of the process of the display control apparatus 120 in the case where the program information is acquired in advance is described with reference to FIG. 3(a) and FIG. 3(b).

FIG. 3(a) and FIG. 3(b) illustrate flowcharts indicating the flow of the process, in the case where the program information is acquired in advance, of the display control apparatus 120 of the first embodiment.

As shown in FIG. 3(a), about the preference program information update process, the preference information acquisition unit 124 of the display control apparatus 120 judges whether the update timing for the preference information has come or not based on the predetermined rule (step S302).

At step S302, when it is judged that the update timing has not come (“NO” in step S302), the flow returns to step S302 again. And the judgment on whether the update timing has come or not, is carried out repeatedly until it is judged that the update timing has come.

At step S302, when it is judged that the update timing has come (“YES” in step S302), the preference information acquisition unit 124 acquires the user's preference information through the interface unit 122 from the preference information management unit 133 of the television 130 (step S303).

As the predetermined rule about the update timing for the preference information, the method of getting the update at the timing (once a day at midnight) when the program guide (EPG) of the digital broadcast is updated, or periodically at midday of every Sunday, and the method of getting the update at irregular timing depending on user's operation, for example, every time the user switches on or views a new program, can be used. But the method is not limited in particular.

The update timing for the preference information can be created on the television 130 side and, when the update timing comes, the preference information picked out by the preference information management unit 133 can be transmitted from the television 130 side to the display control apparatus 120 side.

The search unit 125 of the display control apparatus 120 picks out the preference target program from the preference information acquired from the television 130 by the preference information acquisition unit 124 (step S304).

The communication unit 121 acquires the program information related to the preference target program, which is picked out by the search unit 125, through the network 110 from the program information distribution system 102 (step S305). The program information acquisition unit 126 acquires the program information related to the preference target program through the communication unit 121.

On the other hand, the display process of the preference program information is performed according to the flow shown in FIG. 3(b) asynchronously with the preference program information update process shown in FIG. 3(a).

In FIG. 3(b), when the preference program information display process is started (step S301) by the display control apparatus 120, the power supply monitoring unit 123 of the display control apparatus 120 checks whether the power supply state of the television 130 is changed to power-off or not (step S306). The information related to the power supply state of the television 130 is outputted through the interface unit 132 of the television 130 from the power supply management unit 134 of the television 130. The power supply monitoring unit 123 of the display control apparatus 120 receives the information related to the power supply state through the interface unit 122 and checks whether the power supply state is changed to power-off or not.

At step S306, when it is confirmed that the power supply state is not changed to power-off (“NO” in step S306), the flow returns to step S306 again. And the check on whether the power supply state is changed to power-off or not, is carried out repeatedly until it is confirmed that the power supply state is changed to power-off.

At step S306, when it is confirmed that the power supply state is changed to power-off (“YES” in step S306), at least one piece of the program information related to programs which are planned to broadcast soon is selected (step S307) from among the program information related to the preference target program acquired by the program information acquisition unit 126 at step S305 shown in FIG. 3(a), and the selected program information is displayed on the display unit 127.

The wording of “programs which are planned to broadcast soon”, for example, means the programs which are planned to start to broadcast within a predetermined time (for example, within 3 hours) based on the current time.

When the display control unit 128 acquires the detection result indicating that the power supply state of the television 130 is changed to power-off, from the power supply monitoring unit 123, the display control unit 128 controls the display unit 127 to display the inputted program information (step S308), and completes the preference program information display process (step S309).

By using the display control apparatus 120 of the first embodiment, the program information of a broadcast program, which suits the user's preference, is displayed at the power-off timing of the broadcast reception apparatus such as the television 130. Therefore, the user is urged to view a preference program that may be broadcasted when the user does not watch the television 130, and an effect of preventing the user from missing to view the preference program effectively can be provided.

That is to say, when the power supply of the television 130 is on state, it may be useless to display the program information to urge the user's viewing, because the user continues watching the television 130. Also, when the power supply of the television 130 is off state, it may be useless to display the program information by the display control apparatus 120, because the user is less likely to be near the television 130. The timing when the power supply of the television 130 has just been turned off is an effective timing for preventing the user from missing to view, because the user, who has just stopped viewing the television, is then in front of the television 130.

As above, at the timing when the power supply of the television 130 (a broadcast reception apparatus of the present invention) is turned off, the program information related to the programs which are planned to broadcast soon is selected from among the program information related to the user's preference target program and the selected program information is displayed on the display unit 127 (a program information display unit of the present invention) of the display control apparatus 120. Therefore, the program information which suits the user's preference can be displayed when the power supply of the broadcast reception apparatus is turned off. Moreover, the viewing recommendation information on the recommended program according to the user's preference information can be displayed. Then, it is possible to prevent the user from missing to view a preference program. Moreover, when the user continues to view the television program of the same channel on the broadcast reception apparatus and is unlikely to miss to view the program which the user wants to view, the viewing recommendation information or the like is not displayed. Then, it is possible to prevent redundant information being provided for the user.

As the broadcast reception apparatus of the present invention to which the display control apparatus 120 is connected, the broadcast reception apparatus which has display means such as a personal computer or the like, as well as the television, can be used.

In the first embodiment, the preference information acquisition unit 124 can have the function of the search unit 125. Moreover, the preference information acquisition unit 124 can have the function of the communication unit 121.

In the first embodiment, at step S202 or step S306, the power supply monitoring unit 123 detects that the power supply of the television 130 changes to power-off. The power supply monitoring unit 123 can detect the power-off indication signal which is outputted when a power-off indication is given to the television 130. In this case, the power-off indication signal can be detected so that the program information is displayed on the display unit 127 so as to control the power supply of the television 130 to be turned off after the user confirms the display of the program information.

In the first embodiment, the preference information management unit 133 of the television 130 picks out the user's preference program information. But the preference information management unit 133 can manage the information such as the viewing history, the viewing time or the like of the user (viewer). And the preference information acquisition unit 124 of the display control apparatus 120 can pick out the preference information on the basis of the information acquired from the preference information management unit 133 such as the viewing history, the viewing time or the like of the user.

In the first embodiment, the search unit 125 picks out the user's preference target program. But, the search unit 125 can allow the communication unit 121 to transmit the keyword (such as genre, day of the week, period of time or the performer, which is viewed often by the user) of the user's preference information to the program information distribution system 102 so that the program information distribution system 102 can pick out the user's preference target program on the basis of the keyword of the user's preference information acquired from the search unit 125. Or, the program information distribution system 102 can pick out candidates for the preference target program on the basis of the keyword of the user's preference information acquired from the search unit 125. And the program information acquisition unit 126 can pick out the preference target program on the basis of the candidates for the user's preference target program acquired from the program information distribution system 102.

The keyword of the user's preference information which is transmitted, for picking out the preference target program or the candidates for the preference target program, to the program information distribution system 102 corresponds to an example of a preference information which is transmitted to search to a server according to the present invention.

Then, a display control apparatus of the first embodiment, which has another constitution, is described.

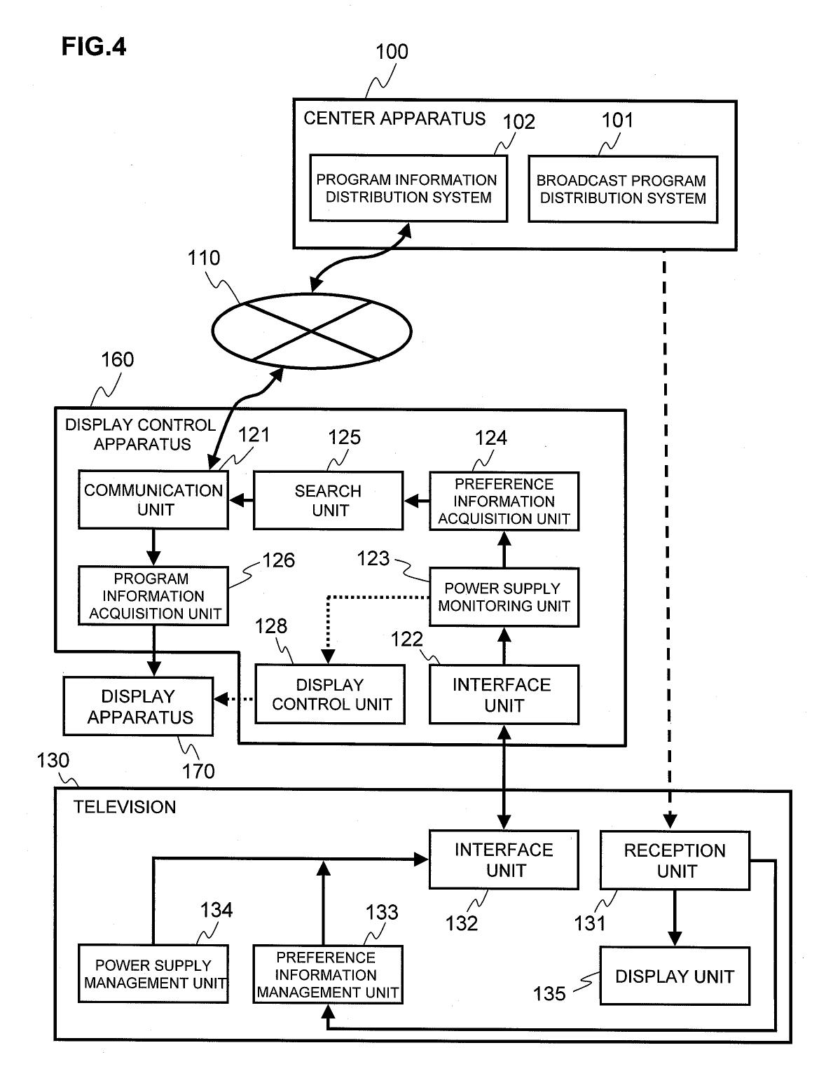

A block diagram of constitutions of the display control apparatus, the television and the center apparatus according to another constitution of the first embodiment are shown in FIG. 4.

In FIG. 4, the display control apparatus 160 of the first embodiment, which has another constitution, is different from the display control apparatus 120 shown in FIG. 1 only in that the display unit 127 is not provided. Since the other components of the display control apparatus 160 are the same as those of the display control apparatus 120, the same reference numerals are used and those explanations are omitted here.

The center apparatus which is connected to the display control apparatus 160 through the network 110 is the same as the center apparatus 100 having the constitution shown in FIG. 1. The television which is connected to the display control apparatus 160 is the same as the television 130 in the constitution shown in FIG. 1. Then, the same reference numerals are used respectively and those explanations are omitted here.

A display apparatus 170 at least has functions equal to those of the display unit 127 shown in FIG. 1, and displays the program information or the like which is outputted from the program information acquisition unit 126 of the display control apparatus 160. As for the display apparatus 170, the display or an ON/OFF state of the power supply is controlled by the display control unit 128 according to the detection result, which is detected by the power supply monitoring unit 123 of the display control apparatus 160, indicating whether the power supply state of the television 130 is changed to power-off or not.

The display apparatus 170 corresponds to an example of a program information display unit arranged outside according to the present invention.

By the constitution as above, the display control apparatus 160 can produce the same effect as the display control apparatus 120 having the constitution shown in FIG. 1.

The constitution of the display apparatus 170 can be equal to that of the television 130. But, a personal computer can be used as the display apparatus 170 because the reception unit for the broadcast is not necessarily required. It is desirable that the display unit of the display apparatus 170 is smaller in size than the television 130 and has lower power consumption so as to produce more power-saving effect.

### Second Embodiment

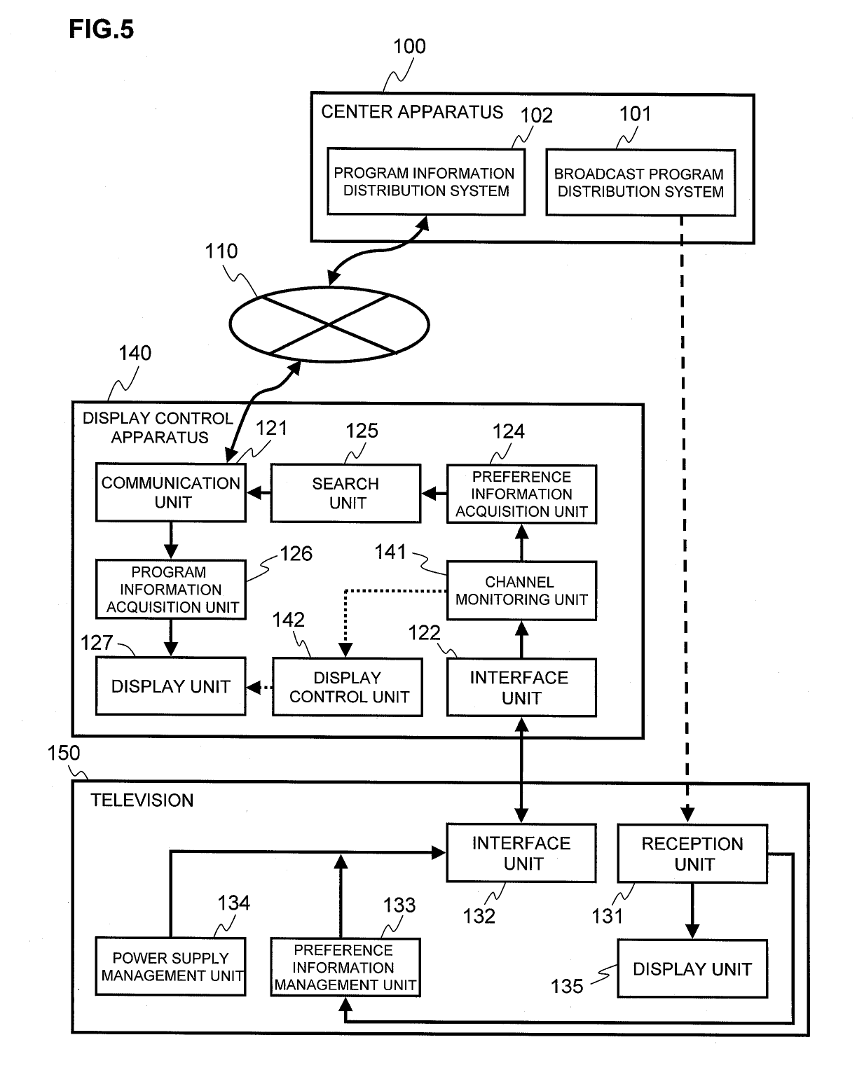

A block diagram of constitutions of a display control apparatus, a television and a center apparatus according to a second embodiment of the present invention are shown in FIG. 5.

In FIG. 5, the display control apparatus 140 is different from the display control apparatus 120 of the first embodiment shown in FIG. 1 in that a channel monitoring unit 141 monitoring the tuning state of the television 150 is provided in substitution for the power supply monitoring unit 123 provided with the display control apparatus 120 and in that a display control unit 142 controlling the display timing for the display unit 127 on the basis of the detection result of the channel monitoring unit 141 is provided. Other blocks (components) of the display control apparatus 140 are the same as those of the display control apparatus 120 respectively, the same reference numerals are used and those explanations are omitted here.

The channel monitoring unit 141 corresponds to an example of a reception apparatus state detection unit according to the present invention.

The center apparatus which is connected to the display control apparatus 140 through the network 110 is the same as the center apparatus 100 of the first embodiment shown in FIG. 1. Then, the same reference numerals are used respectively and those explanations are omitted here.

The constitution of the television 150 connected to the display control apparatus 140 is basically the same as that of the television 130 of the first embodiment shown in FIG. 1 but is different only in that it allows the tuning information to be outputted to the display control apparatus 140 through the interface unit 132 from the reception unit 131.

In the second embodiment, the television 150 may or may not have the power supply management unit 134 because the function of the power supply management unit 134 is not necessarily required.

At the television 150, the reception unit 131 receives the broadcast program distributed from the broadcast program distribution system 101 and decodes the broadcast program. The information related to the received and decoded program is recorded in the preference information management unit 133 as the viewing history. The preference information management unit 133 picks out the user's preference history from the viewing history or from the information related to the viewing history such as the viewing time, the number of times the user viewed or the like. The broadcast program received and decoded by the reception unit 131 is displayed on the display unit 135.

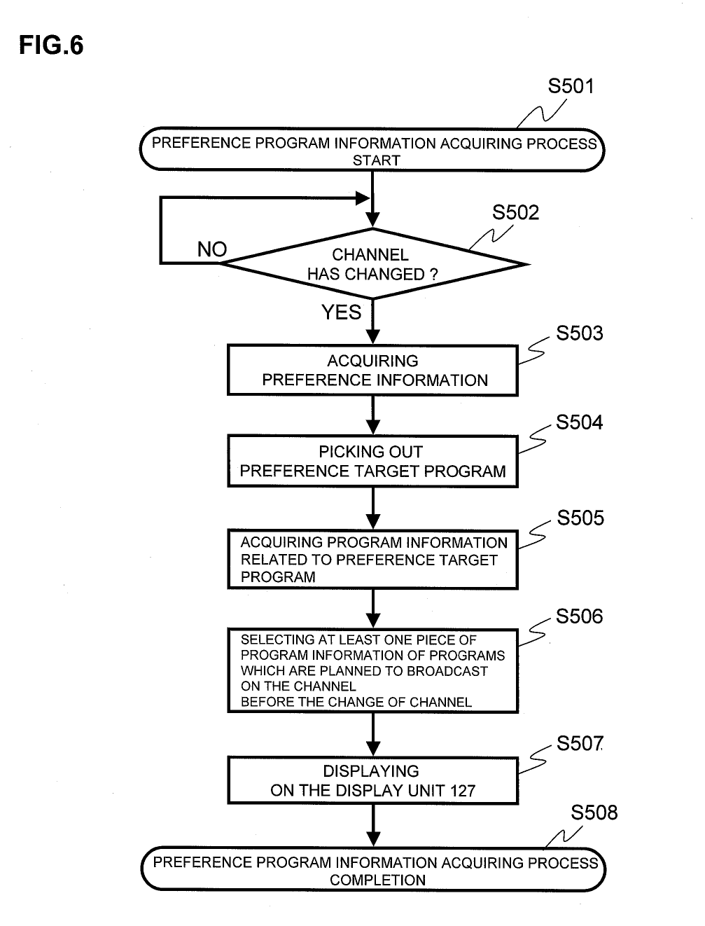

Then, the flow of the process of the display control apparatus 140 of the second embodiment is described with reference to FIG. 6. FIG. 6 illustrates a flowchart indicating the flow of the process of the display control apparatus 140 of the second embodiment.

In FIG. 6, when the preference program information acquiring process is started (step S501) by the display control apparatus 140, the channel monitoring unit 141 of the display control apparatus 140 monitors the tuning state of the television 150 and judges whether the channel is changed or not at the television 150 (step S502).

The information related to the tuning state of the television 150 is outputted through the interface unit 132 of the television 150 from the reception unit 131 of the television 150. The channel monitoring unit 141 of the display control apparatus 140 receives the information related to the tuning state through the interface unit 122 and judges whether the channel is changed or not on the basis of the received information.

The information related to the tuning state acquired by the channel monitoring unit 141 through the interface unit 122 corresponds to an example of an instruction of a change of channels according to the present invention.

At step S502, when it is judged that the channel is not changed (“NO” in step S502), the flow returns to step S502 again. And the judgment on whether the channel is changed or not at the television 150, is carried out repeatedly until it is judged that the channel is changed.

At step S502, when it is judged that the channel is changed (“YES” in step S502), the preference information acquisition unit 124 of the display control apparatus 140 acquires the user's preference information through the interface unit 122 from the preference information management unit 133 of the television 150 (step S503).

The search unit 125 picks out the preference target program, which the user possibly wants to view, from the preference information acquired from the television 150 by the preference information acquisition unit 124 (step S504).

The communication unit 121 acquires the program information related to the preference target program, which is picked out by the search unit 125, through the network 110 from the program information distribution system 102 (step S505). The program information acquisition unit 126 acquires the program information related to the preference target program through the communication unit 121, selects at least one piece of the program information of the programs which are planned to broadcast soon on the channel used before the change of channel, from among the program information related to the preference target program acquired by the program information acquisition unit 126 (step S506), and outputs the selected program information to the display unit 127.

The wording of “programs which are planned to broadcast soon”, for example, means the programs which are planned to start to broadcast within a predetermined time (for example, within 3 hours) based on the current time.

When the display control unit 142 acquires the detection result indicating that the channel is changed, from the channel monitoring unit 141, the display control unit 142 controls the display unit 127 to display the inputted program information (step S507), and completes the preference program information acquiring process (step S508).

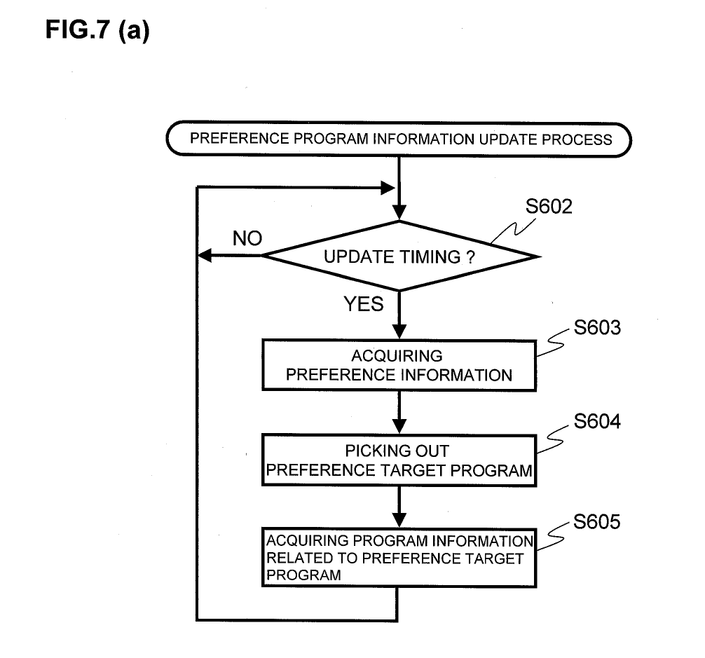

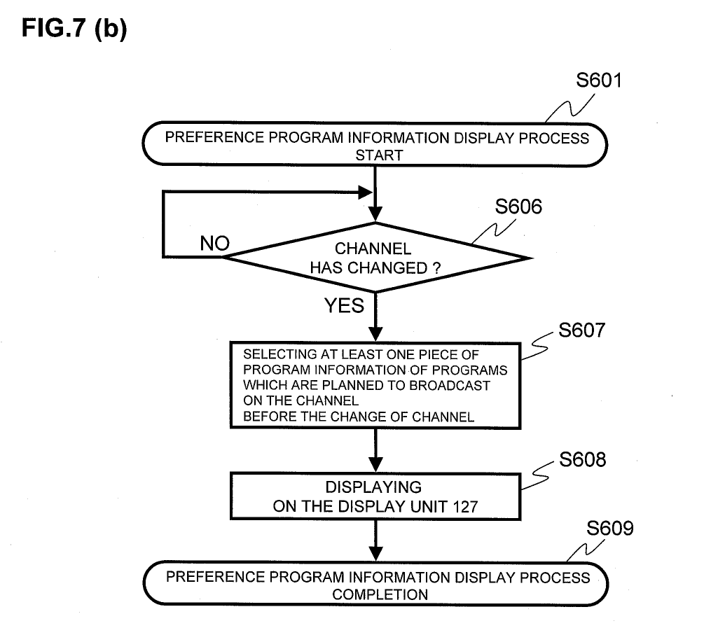

Then, the flow of the process of the display control apparatus 140 in the case where the program information is acquired in advance is described with reference to FIG. 7(a) and FIG. 7(b).

FIG. 7(a) and FIG. 7(b) illustrate flowcharts indicating the flow of the process, in the case where the program information is acquired in advance, of the display control apparatus 140 of the second embodiment.

As shown in FIG. 7(a), about the preference program information update process, the preference information acquisition unit 124 of the display control apparatus 140 judges whether the update timing for the preference information has come or not based on the predetermined rule (step S602).

At step S602, when it is judged that the update timing has not come (“NO” in step S602), the flow returns to step S602 again. And the judgment on whether the update timing has come or not, is carried out repeatedly until it is judged that the update timing has come.

At step S602, when it is judged that the update timing has come (“YES” in step S602), the preference information acquisition unit 124 acquires the user's preference information through the interface unit 122 from the preference information management unit 133 of the television 150 (step S603).

As the predetermined rule about the update timing for the preference information, the method of getting the update at the timing (once a day at midnight) when the program guide (EPG) of the digital broadcast is updated, or periodically at midday of every Sunday, and the method of getting the update at irregular timing depending on user's operation, for example, every time the user switches on or views a new program, can be used. But the method is not limited in particular.

The update timing for the preference information can be created on the television 150 side and, when the update timing comes, the preference information picked out by the preference information management unit 133 can be transmitted from the television 150 side to the display control apparatus 140 side.

The search unit 125 of the display control apparatus 140 picks out the preference target program from the preference information acquired from the television 150 by the preference information acquisition unit 124 (step S604).

The communication unit 121 acquires the program information related to the preference target program, which is picked out by the search unit 125, through the network 110 from the program information distribution system 102 (step S605). The program information acquisition unit 126 acquires the program information related to the preference target program through the communication unit 121.

On the other hand, the display process of the preference program information is performed according to the flow shown in FIG. 7(b) asynchronously with the preference program information update process shown in FIG. 7(a).

In FIG. 7(b), when the preference program information display process is started (step S601) by the display control apparatus 140, the channel monitoring unit 141 of the display control apparatus 140 receives the information related to the tuning state through the interface unit 122 from the reception unit 131 of the television 150 and judges whether the channel is changed or not on the basis of the received information (step S606).

At step S606, when it is judged that the channel is not changed (“NO” in step S606), the flow returns to step S606 again. And the judgment is carried out repeatedly until it is judged that the channel is changed.

At step S606, when it is judged that the channel is changed (“YES” in step S606), at least one piece of the program information of the programs which are planned to broadcast soon on the channel before it is changed is selected (step S607) from among the program information related to the preference target program acquired by the program information acquisition unit 126 at step S605, and the selected program information is displayed on the display unit 127.

The wording of “the programs which are planned to broadcast soon”, for example, means the programs which are planned to start to broadcast within a predetermined time (for example, within 3 hours) based on the current time.

When the display control unit 142 acquires the detection result indicating that the channel is changed at the television 150, from the channel monitoring unit 141, the display control unit 142 controls the display unit 127 to display the inputted program information (step S608), and completes the preference program information display process (step S609).

As above, at the timing which the channel is changed at the television 150 (a broadcast reception apparatus of the present invention), the program information, related to the programs which are planned to broadcast soon on the channel before the change of channel, is selected from among the program information related to the user's preference target program and the selected program information is displayed on the display unit 127 (a program information display unit of the present invention) of the display control apparatus 140. Therefore, missing to view the program which suits the user's preference which is broadcasted afterwards on the channel being viewed by the user till then can be prevented. Moreover, in the state that the user continues to view the television program of the same channel on the broadcast reception apparatus, and in the state that the user doesn't miss to view the program which the user wants to view, the viewing recommendation information or the like is not displayed. Then, it is possible to prevent redundant information being provided for the user.

Displaying the program information at the timing of change of channel causes an effect which urges to view the preference program on the channel before the change of channel, too.

The search unit 125 of the second embodiment can add the channel before change of channel as the search requirement and can pick out the preference target program included in only the channel before change of channel.

By the above, at step S506 and step S607, the program information acquisition unit 126 selects at least one piece of the program information of the programs which are planned to broadcast soon on the channel before the change and displays it on the display unit 127. But, the program information acquisition unit 126 can select at least one piece of the program information of programs which are planned to broadcast soon on the channel other than the channel after the change and displays it on the display unit 127.

In this way, when the program which suits the user's preference is broadcasted afterwards on the channel being viewed by the user till then or on the channel other than the channel after the change, missing to view the program can be prevented.

As shown in FIG. 4 of the first embodiment, the display unit 127 of the display control apparatus 140 is not provided and the program information can be displayed on a display apparatus connected outside.

Like as shown FIG. 5 of the first embodiment, the program information can be displayed on the display apparatus connected outside in substitution for the display unit 127 of the display control apparatus 140, in the second embodiment.

Then, a display control apparatus of the second embodiment, which has another constitution, is described.

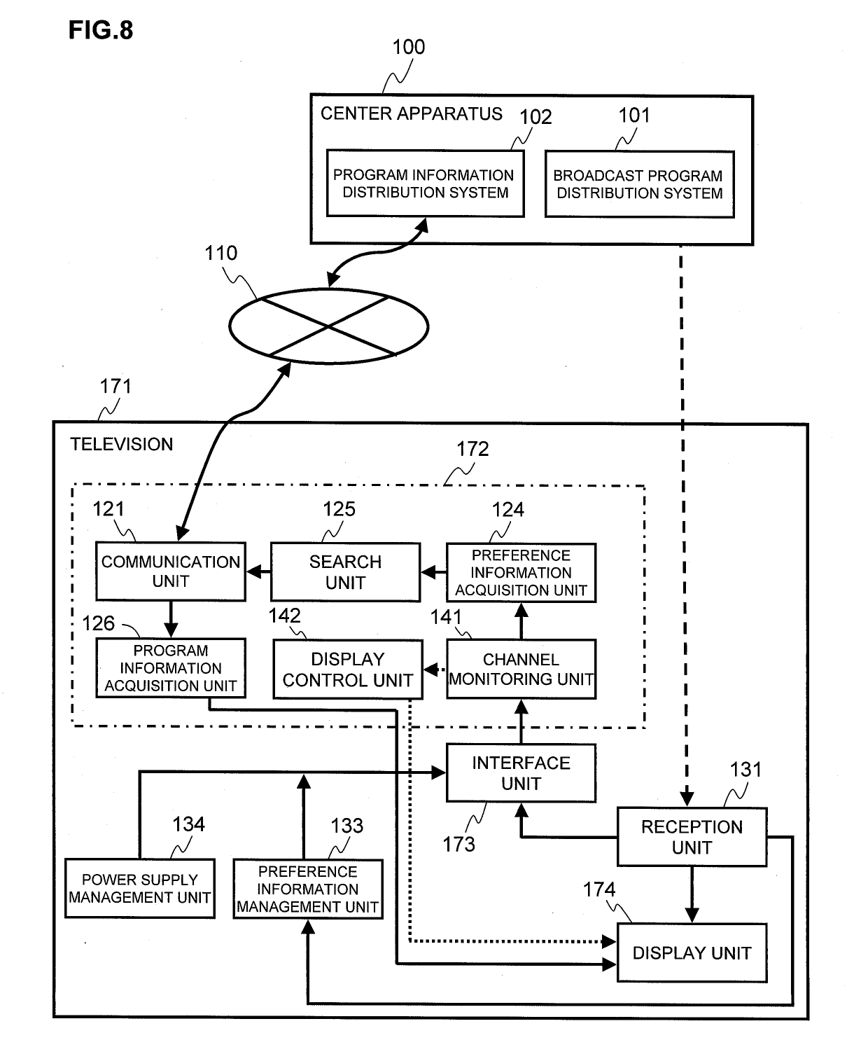

A block diagram of constitutions of the display control apparatus, the television and the center apparatus according to another constitution of the second embodiment are shown in FIG. 8.

The function, as the display control unit 172, of the display control apparatus 140 shown in FIG. 5 is built into the television 171 shown in FIG. 8. The components with the function the same as the block in FIG. 5 are indicated by the same reference numerals.

The display control unit 172 shown in FIG. 8 doesn't have the display unit 127 of the display control apparatus 140 shown in FIG. 5. The program information acquisition unit 126 outputs the program information shown to the user to the display unit 174 which displays the broadcast picture.

The information which is transmitted from the reception unit 131, the preference information management unit 133 and the power supply management unit 134 to the channel monitoring unit 141 is transferred through the interface unit 173. But, the information can be transmitted between these blocks directly without the interface unit 173.

The update and acquiring process, in the television 171 shown in FIG. 8, of the preference program information is the same as the processes in the display control apparatus 140 and the television 150 which are shown in FIG. 6, FIG. 7(a) and FIG. 7(b). But, only the point that the program information is displayed on the display unit 174 which displays the broadcast picture is different.

The display control unit 142 controls displaying small window on a part, for example the lower right area of the display unit 174, of the display unit 174 displaying the broadcast picture. And the display control unit 142 controls displaying the program information outputted from the program information acquisition unit 126 in the window.

### Third Embodiment

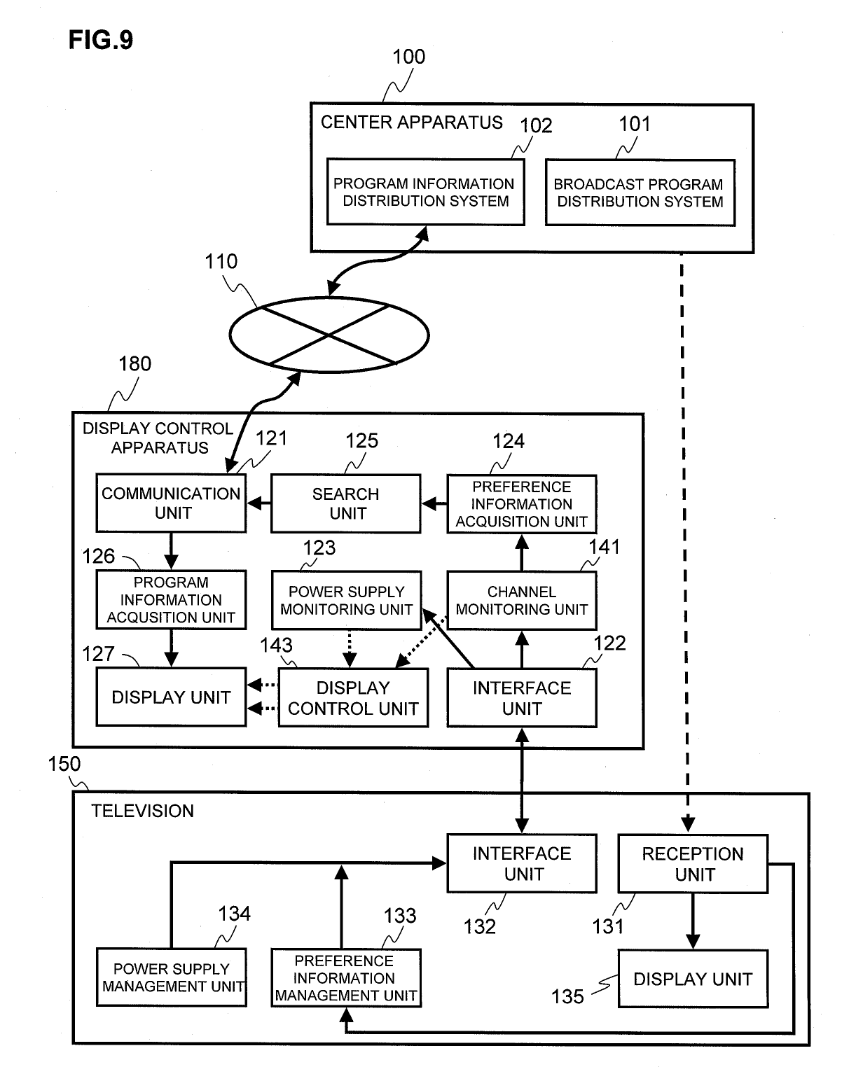

A block diagram of constitutions of a display control apparatus, a television and a center apparatus according to a third embodiment of the present invention are shown in FIG. 9.

The different point of the display control apparatus 180 of the third embodiment shown in FIG. 9 from the display control apparatus 120 of the first embodiment shown in FIG. 1 is only a point of having a channel monitoring unit 141 which is the same as the channel monitoring unit 141 that the display control apparatus 140 of the second embodiment has. Other components of the display control apparatus 180 are the same as those of the display control apparatus 120 respectively, the same reference numerals are used and those explanations are omitted here.

The center apparatus which is connected to the display control apparatus 180 through the network 110 is the same as the center apparatus 100 of the first embodiment shown in FIG. 1. Then, the same reference numerals are used respectively and those explanations are omitted here.

In the display control apparatus 180, a display control unit 143 controls displaying the program information or the like on the display unit 127, on the basis of the result checked by the power supply monitoring unit 123 of whether the power supply state of the television 150 is changed to power-off or not and the result checked by the channel monitoring unit 141 of whether the channel is changed or not at the television 150.

On the other hand, the television 150 connected to the display control apparatus 180 is the same as the constitution of the television 150 of the second embodiment. Like the television 150 of the second embodiment, the television 150 is constituted to be able to output the tuning information for the display control apparatus 180 through the interface unit 132 from the reception unit 131.

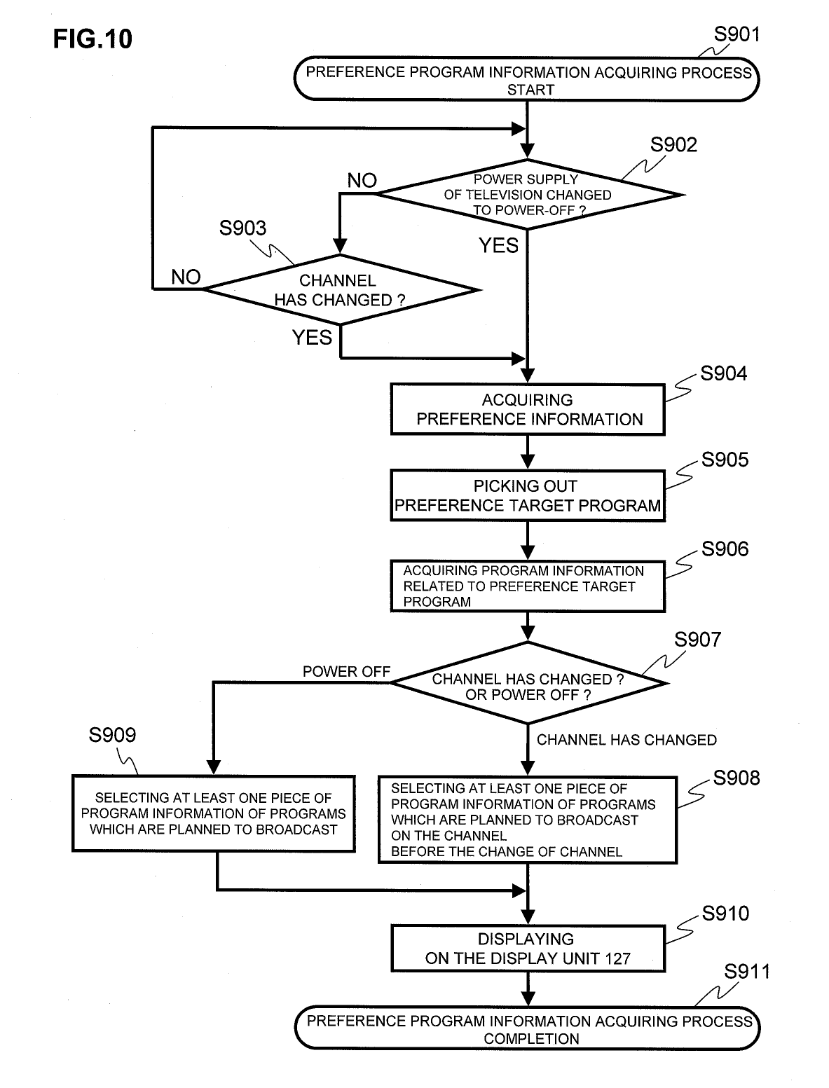

Then, the flow of the process of the display control apparatus 180 of the third embodiment is described with reference to FIG. 10. FIG. 10 illustrates a flowchart indicating the flow of the process of the display control apparatus 180 of the third embodiment.

In FIG. 10, when the preference program information acquiring process is started (step S901) by the display control apparatus 180, the power supply monitoring unit 123 of the display control apparatus 180 checks whether the power supply state of the television 150 is changed to power-off or not (step S902).

At step S902, when the power supply monitoring unit 123 checks that the power supply state of the television 150 is not changed to power-off (“NO” in step S902), the channel monitoring unit 141 of the display control apparatus 180 checks whether the channel is changed or not at the television 150 (step S903).

At step S903, when the channel monitoring unit 141 checks that the channel is not changed (“NO” in step S903), the flow returns to step S902 again and whether the power supply state of the television 150 is changed to power-off or not is checked.

At step S902, when the power supply monitoring unit 123 checks that the power supply state of the television 150 is changed to power-off (“YES” in step S902), and at step S903, when it is checked that the channel is changed (“YES” in step S903), that is, when either change of the state of the power supply or the state of the channel of the television 150 is detected, the preference information acquisition unit 124 of the display control apparatus 180 acquires the user's preference information through the interface unit 122 from the preference information management unit 133 of the television 150 (step S904).

The search unit 125 of the display control apparatus 180 picks out the preference target program from the preference information acquired from the television 150 by the preference information acquisition unit 124 (step S905).

The communication unit 121 acquires the program information related to the preference target program, which is picked out by the search unit 125, through the network 110 from the program information distribution system 102 (step S906). The program information acquisition unit 126 acquires the program information related to the preference target program through the communication unit 121.

When the program information acquisition unit 126 acquires the program information related to the preference target program, the program information acquisition unit 126 checks that the change of state in the television 150 is which of “the change of channel” or “the power supply off” (step S907).

At step S907, when the program information acquisition unit 126 confirms that the change of state in the television 150 is “the change of channel”, the program information acquisition unit 126 selects (step S908) at least one piece of the program information of programs which are planned to broadcast soon on the channel before the change of channel from among the acquired program information, and outputs it on the display unit 127. At step S907, when the program information acquisition unit 126 confirms that the change of state in the television 150 is “the power supply off”, the program information acquisition unit 126 selects (step S909) at least one piece of the program information of programs which are planned to broadcast soon from among the acquired program information, and outputs it on the display unit 127.

The wording of “programs which are planned to broadcast soon”, for example, means the programs which are planned to start to broadcast within a predetermined time (for example, within 3 hours) based on the current time.

When the display control unit 142 acquires the detection result indicating that the power supply state of the television 150 is changed to power-off or that the channel is changed, the display control unit 142 controls the display unit 127 to display the inputted program information (step S910), and completes the preference program information acquiring process (step S911).

At step S908, in substitution for selecting at least one piece of the program information of the programs which are planned to broadcast soon on the channel before the change of channel, at least one piece of the program information of programs which are planned to broadcast soon on the channel other than the channel after the change can be selected.

As above, at the timing that the power supply of the television 150 (a broadcast reception apparatus of the present invention) is turned off, the program information related to programs which are planned to broadcast soon is selected from among the program information related to the user's preference target program. Or, at the timing that the channel is changed at the television 150, the program information related to programs which are planned to broadcast soon on the channel before it is changed is selected from among the program information related to the user's preference target program. And the selected program information is displayed on the display unit 127 (a program information display unit of the present invention) of the display control apparatus 180. Therefore, the program information which suits the user's preference can be displayed when the power supply of the broadcast reception apparatus is off. Moreover, the viewing recommendation information on the recommend program according to the user's preference information can be displayed. Then, missing to view the preference program can be prevented. Moreover, in the state that the user continues to view the television program of the same channel on the broadcast reception apparatus, and in the state that the user doesn't miss to view the program which the user wants to view, the viewing recommendation information or the like is not displayed. Then, it is possible to prevent redundant information being provided for the user.

Moreover, when it is confirmed that the change of state of the television 150 is power supply off, the program information of the preference target program from among all channels can be displayed. And, when it is confirmed that the change of state of the television 150 is change of channel, the program information of the preference target program from among channels before change of channel can be displayed. Then, the viewing recommendation information of program can be shown more effectively.

In the third embodiment, a case to acquire the preference information after confirming whether the power supply is changed to off or not, or a case to acquire the preference information after confirming whether the channel is changed or not, as examples, are described. But, the preference information can be acquired in advance like the first and second embodiments.

As shown in FIG. 4 of the first embodiment, the display unit 127 of the display control apparatus 180 is not provided and the program information can be displayed on a display apparatus connected outside.

As shown in FIG. 8 of the second embodiment, the function of the display control apparatus 180 is included in the television, and the program information can be displayed over the broadcast picture at a part of the display unit of the television.

The present invention can provide the display control apparatus having each component of the first, second and third embodiments. Moreover, the present invention can provide a display control integrated circuit having each component included in the display control apparatus, a display control method including processes at each component included in the display control apparatus as each step, and a computer program for display control executing the display control method by a computer. And the computer program for display control can be distributed through the recording medium such a CD-ROM (Compact Disc-Read Only Memory) or the internet.

Moreover, the program of the present invention is a program for causing a computer to execute the operations of the preference information acquisition step of acquiring a preference information of a viewer from the broadcast reception apparatus, the program information acquisition step of acquiring the program information of a preference target program which suits the preference information, from the server, and the display control step of controlling a start of a display of the program information, on the basis of at least one of the instruction of the power supply off and the instruction of the change of channels, of the above-described display control method of the present invention and is a program which operates in cooperation with the computer.

Moreover, the recording medium of the present invention is a recording medium having recorded thereon a program for causing a computer to execute the preference information acquisition step of acquiring a preference information of a viewer from the broadcast reception apparatus, the program information acquisition step of acquiring the program information of a preference target program which suits the preference information, from the server, and the display control step of controlling a start of a display of the program information, on the basis of at least one of the instruction of the power supply off and the instruction of the change of channels, of the above-described display control method of the present invention and is a computer-readable recording medium, the program of which, when read, is used in cooperation with the computer.

Moreover, the above-mentioned “operation of the step” of the present invention means the operation of all or a part of the step.

Moreover, in one use form of the program according to the present invention, the program may be recorded in the recording medium such as ROM readable by the computer, and operated in cooperation with the computer.

Moreover, in another use form of the program according to the present invention, the program may be transmitted across the network such as the Internet, or through the transmission media such as light or electric wave, read by the computer and operated in cooperation with the computer.

The computer according to the present invention described above is not limited to pure hardware such as a CPU and may include firmware, an OS, and peripheral equipment.

As described above, the configuration of the present invention may be implemented by software or hardware.

### INDUSTRIAL APPLICABILITY

The display control apparatus, the display control method and the like according to the present invention have an effect that can prevent a user from missing to view a preference program by showing recommend programs according to user's preference information in an appropriate timing, without offering redundant information. Then, the present invention is useful as a display control apparatus, a display control method, and the like which offers the program information according to the viewing state of the user.

### DESCRIPTION OF SYMBOLS

100 Center apparatus
101 Broadcast program distribution system
102 Program information distribution system
110 Network
120 Display control apparatus
121 Communication unit
122 Interface unit
123 Power supply monitoring unit
124 Preference information acquisition unit
125 Search unit
126 Program information acquisition unit
127 Display unit
128 Display control unit
130 Television
131 Reception unit
132 Interface unit
133 Preference information management unit
134 Power supply management unit
135 Display unit
140 Display control apparatus
141 Channel monitoring unit
142 Display control unit
143 Display control unit
150 Television
160 Display control apparatus
170 Display apparatus
171 Television
172 Display control unit
173 Interface unit
174 Display unit
180 Display control apparatus
411 Program information server
412 Internet
413 Home LAN
421 Display control terminal
422 Access point
423 Router
424 Recording apparatus
425 Picture display sound reproduction apparatus

1. A display control apparatus which is connected through a network to a server having program information, works in cooperation with a broadcast reception apparatus having a display function, and controls a display of the program information of a broadcast program, the display control apparatus comprising:
a preference information acquisition unit which acquires a preference information of a viewer from the broadcast reception apparatus;
a program information acquisition unit which acquires the program information of a preference target program which suits the preference information, from the server;
a reception apparatus state detection unit which detects at least one of an instruction of a power supply off to the broadcast reception apparatus and an instruction of a change of channels to the broadcast reception apparatus;
a program information display unit which displays at least a part of the program information; and
a display control unit which controls a start of a display of the program information, on the basis of at least one of the instruction of the power supply off and the instruction of the change of channels.

2. The display control apparatus according to claim 1, comprising:
a search unit which searches the preference target program which suits the preference information; and
a communication unit which receives the program information about the preference target program specified by the search unit, from the server, wherein
the program information acquisition unit acquires the program information of the preference target program from the communication unit.

3. The display control apparatus according to claim 2, wherein
the search unit performs the search of the preference target program against an EPG information which is acquired from the broadcast reception apparatus.

4. The display control apparatus according to claim 1, comprising a communication unit which transmits the preference information to the server and receives the program information of the preference target program which suits the preference information, the preference target program being searched by the server, wherein
the program information acquisition unit acquires the program information of the preference target program from the communication unit.

5. The display control apparatus according to claim 1, wherein
the display control unit controls in such a manner that the display of the program information starts in a case that a channel after the change of channel differs from a channel of the preference target program, when the instruction of the change of channels is detected.

6. The display control apparatus according to claim 5, wherein
the display control unit controls in such manner that the display of the program information starts only in a case that a channel before the change of channel is the same as the channel of the preference target program, when the instruction of the change of channels is detected.

7. The display control apparatus according to claim 1, wherein
the program information display unit is not built into a body section of the display control apparatus but is arranged outside of the body section.

8. The display control apparatus according to claim 1, wherein
the display control apparatus is incorporated in the broadcast reception apparatus, and
a screen serves as the program information display unit, the screen displaying a picture of the broadcast program of the broadcast apparatus.

9. A display control method which acquires program information of a broadcast program through a network from a server having the program information, works in cooperation with a broadcast reception apparatus having a display function, and displays the program information, the display control method comprising:
a preference information acquisition step of acquiring a preference information of a viewer from the broadcast reception apparatus;
a program information acquisition step of acquiring the program information of a preference target program which suits the preference information, from the server;
a reception apparatus state detection step of detecting at least one of an instruction of a power supply off to the broadcast reception apparatus and an instruction of a change of channels to the broadcast reception apparatus; and
a display control step of controlling a start of a display of the program information, on the basis of at least one of the instruction of the power supply off and the instruction of the change of channels.

10. A non-transitory computer-readable medium having a program stored thereon for causing a computer to execute display control method according to claim 9.

11. (canceled)

12. The display control apparatus according to claim 2, wherein
the program information display unit is not built into a body section of the display control apparatus but is arranged outside of the body section.

13. The display control apparatus according to claim 3, wherein
the program information display unit is not built into a body section of the display control apparatus but is arranged outside of the body section.

14. The display control apparatus according to claim 4, wherein
the program information display unit is not built into a body section of the display control apparatus but is arranged outside of the body section.

15. The display control apparatus according to claim 5, wherein
the program information display unit is not built into a body section of the display control apparatus but is arranged outside of the body section.

16. The display control apparatus according to claim 6, wherein
the program information display unit is not built into a body section of the display control apparatus but is arranged outside of the body section.

17. The display control apparatus according to claim 2, wherein
the display control apparatus is incorporated in the broadcast reception apparatus, and
a screen serves as the program information display unit, the screen displaying a picture of the broadcast program of the broadcast apparatus.

18. The display control apparatus according to claim 3, wherein
the display control apparatus is incorporated in the broadcast reception apparatus, and
a screen serves as the program information display unit, the screen displaying a picture of the broadcast program of the broadcast apparatus.

19. The display control apparatus according to claim 4, wherein
the display control apparatus is incorporated in the broadcast reception apparatus, and
a screen serves as the program information display unit, the screen displaying a picture of the broadcast program of the broadcast apparatus.

20. The display control apparatus according to claim 5, wherein
the display control apparatus is incorporated in the broadcast reception apparatus, and
a screen serves as the program information display unit, the screen displaying a picture of the broadcast program of the broadcast apparatus.

21. The display control apparatus according to claim 6, wherein
the display control apparatus is incorporated in the broadcast reception apparatus, and
a screen serves as the program information display unit, the screen displaying a picture of the broadcast program of the broadcast apparatus.
